(19) United States
(12) Patent Application Publication
(10) Pub. No.: US 2017/0286933 A1
(43) Pub. Date: Oct. 5, 2017

(54) CONTENT PROTECTION

(71) Applicants: Joseph Medeiros, III, Santa Clara, CA (US); Joseph Medeiros, JR., Santa Clara, CA (US)

(72) Inventors: Joseph Medeiros, III, Santa Clara, CA (US); Joseph Medeiros, JR., Santa Clara, CA (US)

(21) Appl. No.: 15/089,460

(22) Filed: Apr. 1, 2016

(51) Int. Cl. G06Q 20/12; G06F 21/10

(52) U.S. Cl. CPC G06Q 20/1235; G06F 21/10; G06F 2221/0704; G06Q 2220/18

(57) ABSTRACT

To protect digital content, a content player is installed on a content user device. A unique identifier for the content player installed on the content user device is provided to a central content storage entity. A license to play proprietary digital content stored on the central content storage is purchased from a storefront on the central content storage entity. The proprietary digital content includes an original work of authorship protectable by copyright. Content-player-specific digital content from the central content storage is downloaded to the content user device. The content-player-specific digital content includes encoded content of the proprietary digital content embedded with the unique identifier. The content player confirms that the unique identifier embedded with the encoded content matches the unique identifier provided for the content player before allowing play of the proprietary digital content on the content player.

### BACKGROUND

Digital rights management (DRM) protects creative works from being duplicated. Owners of content such as music recordings and videos desire DRM to protect their revenue stream. DRM technology is often used to control the use, modification and distribution of content protected by copyright.

### BRIEF DESCRIPTION OF THE DRAWINGS

FIG. 1 is a simplified block diagram that shows content owners and content users connected to a central content storage entity through the Internet, in accordance with an embodiment.

FIG. 2 shows a simplified block diagram of a central content storage entity, in accordance with an embodiment.

FIG. 3 shows a simplified block diagram of a content user device, in accordance with an embodiment.

FIG. 4 is a simplified flow chart illustrating upload of content from a content owner to a central content storage entity, in accordance with an embodiment.

FIG. 5 is a simplified flow chart illustrating download of content from a central content storage entity, in accordance with an embodiment.

FIG. 6 is a simplified flow chart illustrating play of content by a content user, in accordance with an embodiment.

FIG. 7 is a simplified flow chart illustrating download of content from a central content storage entity, in accordance with an alternative embodiment.

FIG. 8 is a simplified flow chart illustrating play of content by a content user, in accordance with an alternative embodiment.

### DESCRIPTION OF THE EMBODIMENTS

In accordance with various embodiments, digital content is protected. A content player is installed on a content user device. A unique identifier for the content player installed on the content user device is provided to a central content storage entity. The central content storage entity receives proprietary digital content. The proprietary digital content includes an original work of authorship protectable by copyright. The central content storage entity encodes the proprietary digital content to produce encoded content.

The central storage entity provides a storefront that allows purchase of a license to play the proprietary digital content on the content player. When the license to play the proprietary content on the content player is purchased, the unique identifier is embedded with the encoded content to produce content-player-specific digital content. The content-player-specific digital content is forwarded from the central content storage entity to the content player installed on the content user device. The content player confirms that the unique identifier embedded with the encoded content matches the unique identifier provided for the content player before allowing play of the proprietary digital content on the content player.

For example, when embedding the unique identifier with the encoded content, the encoded content is decoded to recover the proprietary digital content. The unique identifier is added to the proprietary digital content. Then the proprietary digital content is encoded with the unique identifier to produce the content-player-specific digital content.

For example, in an alternative embodiment, when embedding the unique identifier with the encoded content, the unique identifier is added to the encoded content. The encoded content with the proprietary digital content is further encoded to produce the content-player-specific digital content.

For example, in an alternative embodiment, when embedding the unique identifier with the encoded content, the unique identifier is added to the encoded content to produce the content-player-specific digital content.

For example, when embedding the unique identifier with the encoded content, the encoded content is also embedded with a second unique identifier that identifies a second content player within a second content user device.

For example, when embedding the unique identifier with the encoded content, the encoded content is also embedded with a plurality of additional unique identifiers. Each additional unique identifier identifies an additional content player within an additional content user device.

For example, when embedding the unique identifier with the encoded content, an expiration date is included within the encoded content. The content player confirms that the expiration date has not passed before allowing play of the proprietary digital content on the content player.

For example, at least one unique identifier is embedded into files stored on a digital storage media so that when the files are extracted or imported from the digital storage media, the files will be playable only on a content player with a unique identifier that matches one of the at least one unique identifier embedded into the files stored on the digital storage media.

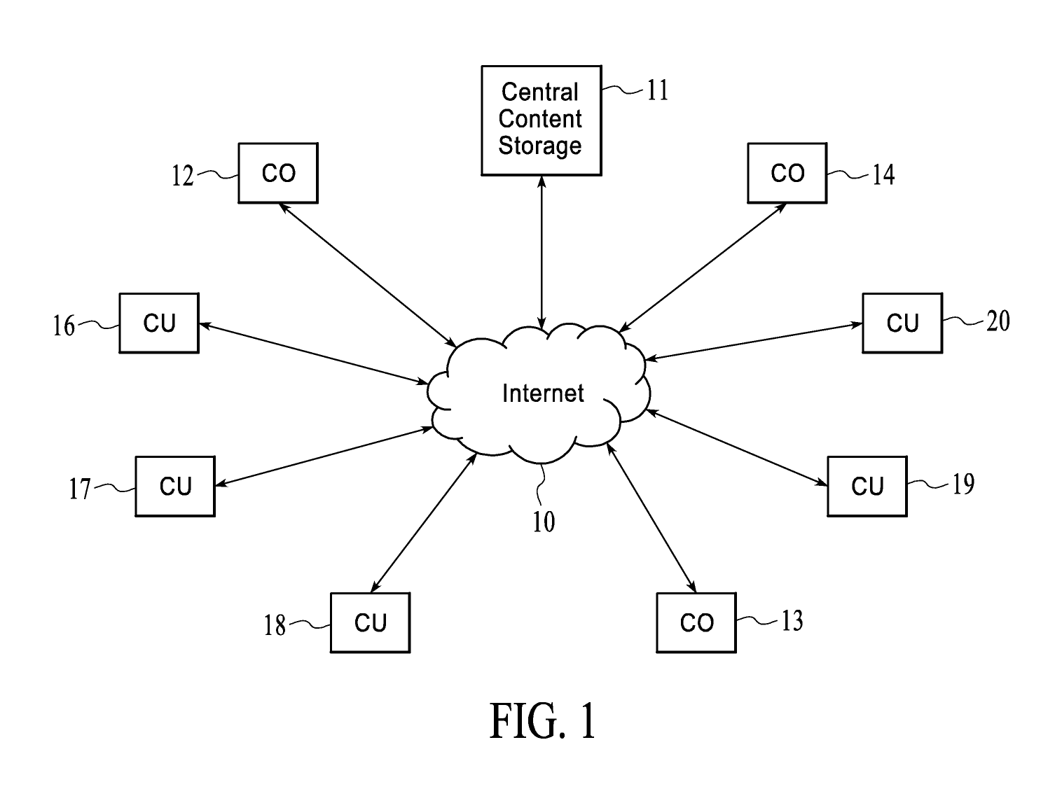

FIG. 1 shows a simplified block diagram where a central content storage entity 11 is accessible through the Internet 10. Content owners can upload content to central content storage entity 11 through the Internet. A content owner (CO) 12, a content owner (CO) 13 and a content owner (CO) 14 represent content owners available to upload content to central content storage entity 11.

Content users can download content from central content storage entity 11 through the Internet. A content user (CU) 16, a content user (CU) 17, a content user (CU) 18, a content user (CU) 19 and a content user (CU) 20 represent content users available to download content from central content storage entity 11.

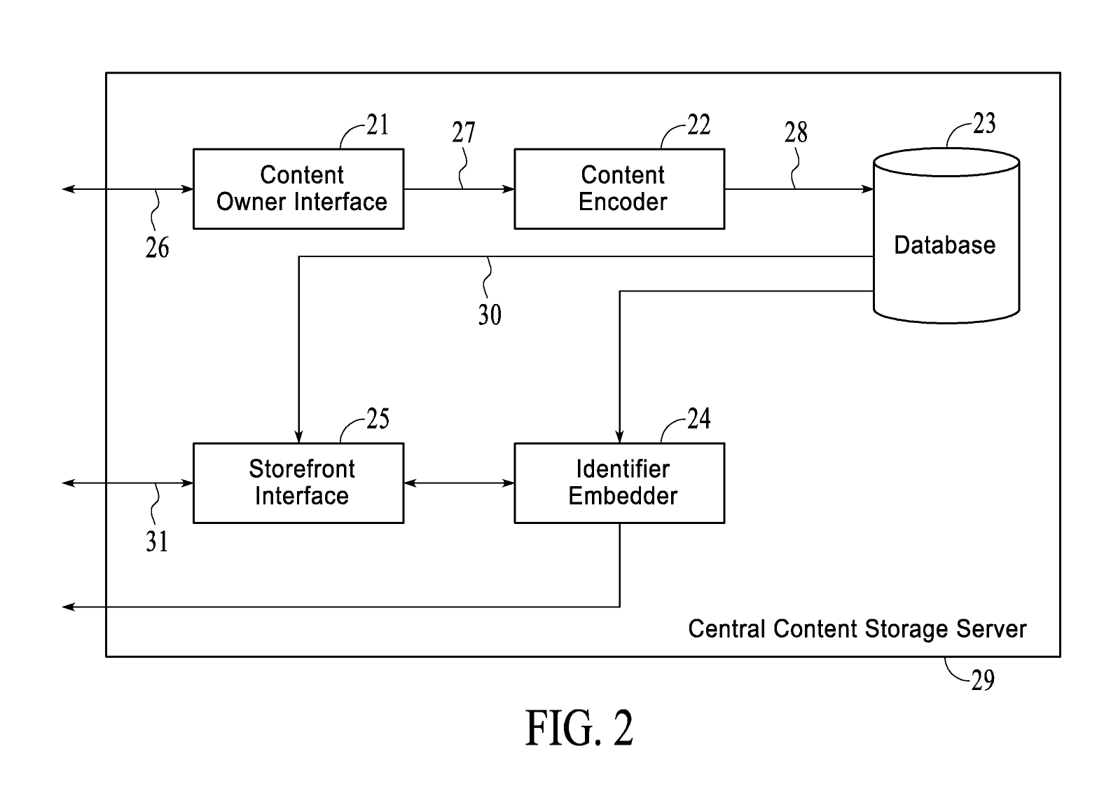

FIG. 2 shows a simplified block diagram of a central content storage server 29. For example, central content storage server 29 is a network server that implements central content storage entity 11, shown in FIG. 1.

A content owner interface 21 with a connection 26 to the Internet 10, is used to receive proprietary digital content uploads from content owners and otherwise interface with content owners. For example, the proprietary digital content includes an original work of authorship protectable by copyright. For example, the proprietary digital content is in a known format for video, audio or e-book. For example, the Wave Form Audio File Format (.wav), QuickTime File Forman (QTFF) (utilizing filename extension .mov and .qt), Audio Interchange File format (.aiff), MPEG-4 (using extensions .mp4, .m4a, m4p, etc), or any other number of file formats can be used for the proprietary digital content.

As illustrated by an arrow 27, proprietary digital content that is uploaded from content owners is encoded by a content encoder 22 and, as illustrated by an arrow 28, placed in a database 23. For example, the encoding includes compression. The encoding is performed using known encoding and compression techniques. In alternative embodiment, a proprietary encoding and compression algorithm can be used. For example, a lossless translation that produces a compressed digital file can be used. For example, for encoded content, unique file extensions can be used to indicate that the encoded data is protected by a special encoded scheme. For example, one proprietary file extension can be used for encoded music files, another proprietary file extension can be used for encoded video files and another proprietary extension can be used for encoded e-books.

For example, when a content owner uploads proprietary digital content to central content storage server 29, for encoding and storage, additional steps can be taken to prevent piracy through a digital player. For example, when a unique identifier is embedded before downloading a music file, the unique identifier can be inserted in random locations in the digital content to be played. A content player authorized to play the digital content will recognize and skip over the unique identifier when playing the digital content, with no loss of playback quality. However, when an attempt to pirate the digital content is made, the inserted unique identifiers in the digital content will degrade the quality of sound produced from the digital content resulting in errors when the digital content is copied or played by digital players not authorized to play the digital content.

As approved by a content owner, content can be advertised in a storefront interface 25. For example, within storefront interface 25, each content owner can have a localized storefront interface for the content owner. Alternatively, or in addition, localized storefronts can feature multiple artists. The content owner can select which content to make available, at what cost and in which localized storefront or storefronts. This is represented by an arrow 30. For advertising purposes, a portion or the content can be made instantly available to content users that are browsing in storefront interface 25. An owner of content may, for example, include additional advertising content in the localized store such as news about music artists and so on.

Arrow 31 represents content users accessing storefront interface 25. For example, when browsing content available in storefront interface 25, content users can download and play free content available from the storefront interface. For example, the free content may include a sample portion of content available for purchase. For purchased content to be made permanently available to a content user, a content encoder 22 receives a unique identifier from the content user. For example, the unique identifier includes a serial number or other unique identifier that identifies hardware on which the purchased content is to be played. Alternatively, or in addition, the unique identifier includes a serial number of a content player within a content user device. Identifier embedder 24 encodes the unique identifier into the purchased content before the content is downloaded to the content user. For example, the unique identifier is added to the proprietary digital content before or after encoding to produce content-player-specific digital content. If the unique identifier is added to the proprietary digital content after encoding, the combination of the unique identifier and the encoded proprietary digital content can be additionally encoded to produce the content-player-specific digital content. Alternatively, or in addition, the unique identifier is used as part of the encoding algorithm, for example, where some derivation of the unique identifier is used as part of an encryption key to encode the proprietary digital content to produce the content-player-specific digital content.

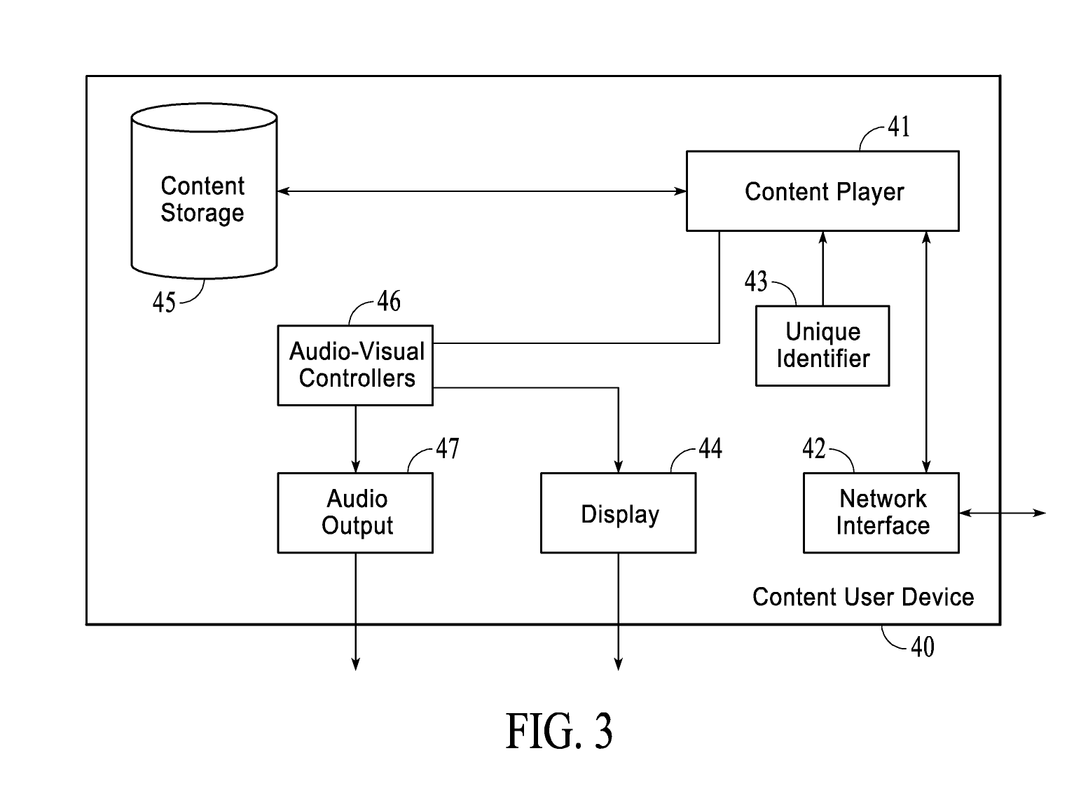

FIG. 3 is a simplified block diagram of a content user device that is used, for example, by a content user such as represented in FIG. 1 by content users 16, 17, 18, 19 and 20. A network interface 42 allows access to the Internet 10, for example, through a wireless connection or a cellular connection. A content player is, for an example, an application downloaded from storefront interface 25 shown in FIG. 2. Content downloaded from storefront interface 25 can be stored, for example, in content storage 45, implemented in hardware memory of content user device 40. Content player 41 accesses unique identifier 43 from within content user device 40 in order to identify content user device 40 to storefront interface 25. Content player 41 also accesses and uses unique identifier 43 from within content user device 40 to decode when playing content-player-specific digital content purchased from storefront interface 25. Content player 41 plays decoded content using audio-visual controllers 46 within content user device 40. For example, visual content is displayed to a user using a local display 44 of content user device 40. Audio output 47 of content user device is used to play audio content, for example, through localized speakers of content user device 40, earphones, or a remote speaker system accessible wirelessly or through wired connections.

Content player 41 can also include auxiliary software and/or hardware to detect when content being played is being recorded. Detection will result in content player 41 stopping play. For example, transmissions from content user device 40 through wired connections or wireless connections can be monitored to detect digital content leaving content user device 40 when content player 41 plays protected content. When content player 41 plays protected video recordings other applications running on content user device 40 can be monitored to protect these applications from capturing video content played by content player 41. Content player 41 will immediately pause play of a recording when unauthorized capture of content is detected. For example, when content player 41 displays content from a protected e-book, content player will disable the ability of content user device 40 to capture screenshots of the e-book. Copy and paste functions of content user device 40 are also disabled for content from protected e-books displayed by content player 41.

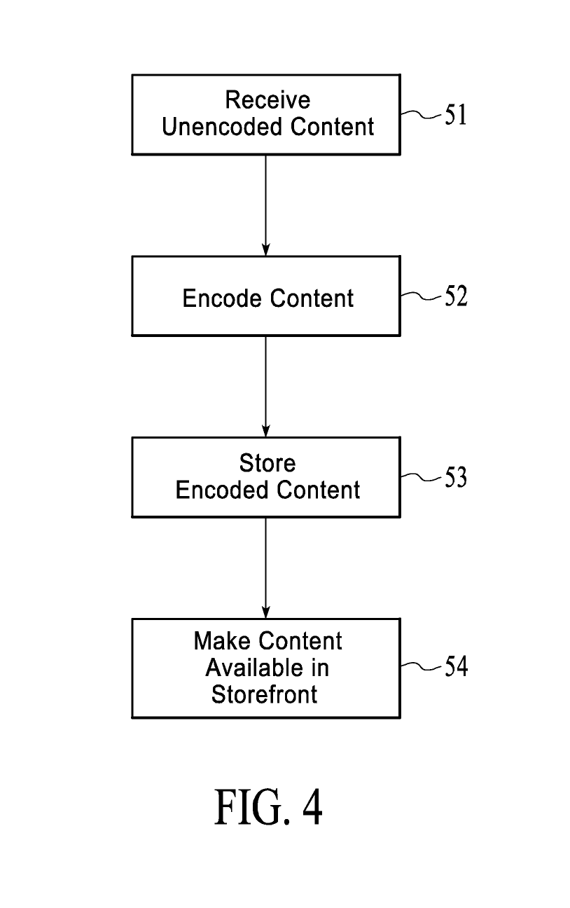

FIG. 4 is a simplified flow chart illustrating upload of content from a content owner to central content storage device 29. For example, the unencoded content is proprietary digital content that includes an original work of authorship protectable by copyright. In a block 51, unencoded content is sent from the content owner to central content storage device 29. In block 52, content encoder 22 (shown in FIG. 2) encodes the content. For example, the encoding includes compression. In a block 53, the encoded content is stored in database 23. For example, central content storage device 29 discards the original unencoded content once the proprietary digital content has been encoded and stored in database 23. In a block 54, the content is made available for purchase on storefront interface 25 as authorized by the content owner. For example, the content owner is able to specify the price to purchase the content and so on.

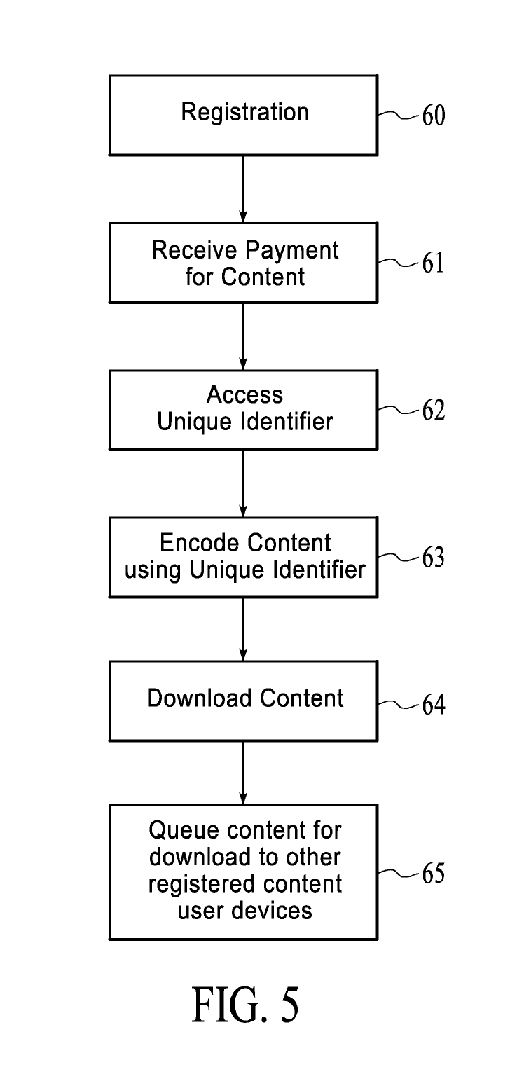

FIG. 5 is a simplified flow chart illustrating download of content from central content storage interface 25 to a content user using content user device 40 shown in FIG. 3. In a block 60 a content user or potential content user registers with storefront interface 25. For example, registration includes the content user downloading and/or launching loading content player 41 in content user device 40. Content player 41 identifies unique identifier 43, as discussed above. Storefront interface 25 obtains unique identifier 43 from content player 41. The content user is now able to browse storefront interface 25 and make purchases for playing of any purchased content on content player 25. For example, registration can include storing of consumer information for content user such as name, contact information and payment information. For example, contact information can contain phone numbers, e-mail address, mail address and so on. Payment information may contain credit card, debit card or bank account information, etc. For example, the content user may register more than one content user device. This will allow purchased content to be automatically downloaded to all content user devices registered for a content user. For example, up to a predetermined number of content user devices may be registered to a content user account. For example, the predetermined number is one, two, three, four, five or some other number. Once registered a registered user may request to follow particular content owners. This can take the form, for example, of the registered user requesting updated information on an artist, movie, author, particular type of item, etc. Notifications can be sent out as requested by the registered user. These notifications can be through e-mail, SMS messaging, or using some other messaging or communication system.

In a block 61, storefront interface 25 receives payment from the content user for the content the user desires to purchase. For example, this purchase is made using a credit card, debit card or bank transfer. In a block 62, storefront interface 25 accesses unique identifier for registered devices for the content user. For example, each unique identifier is accessed from information previously provided to storefront interface 25 from content user device 40 and other content user devices registered in the content users account. Alternatively, the unique identifier is obtained directly from content user device 40 after purchase of the content. In a block 63, identifier embedder 24 encodes or re-encodes the purchased content so that the unique identifier or each content user device registered for the content user is embedded in the resulting purchased content.

In a block 64, storefront interface 25 downloads the purchased content with the embedded unique identifier to content user device 40. The purchased content is then available to be played on content user device.

In a block 65, store interface 25 queues up the purchased content to be downloaded to any additional content user devices registered for the user. The unique identifier for each content user device registered for the content user is included in the purchased content to produce content-player-specific digital content. This will allow the purchased content to play on all the consent user devices registered to the content user's account. If the content user desires to download purchased content to more than the maximum number of content user devices, the content user must make an additional purchase of the content, or must remove the content from a device on which it has been previously downloaded. This allows, for example, purchased content to be played on more than one device. For example, a content user may choose to place purchased content on one or more of a personal computer, tablet computer, smart phone, MP3 player, Apple Ipod, etc. This is possible provided the maximum number of content user devices for purchased content is not exceeded.

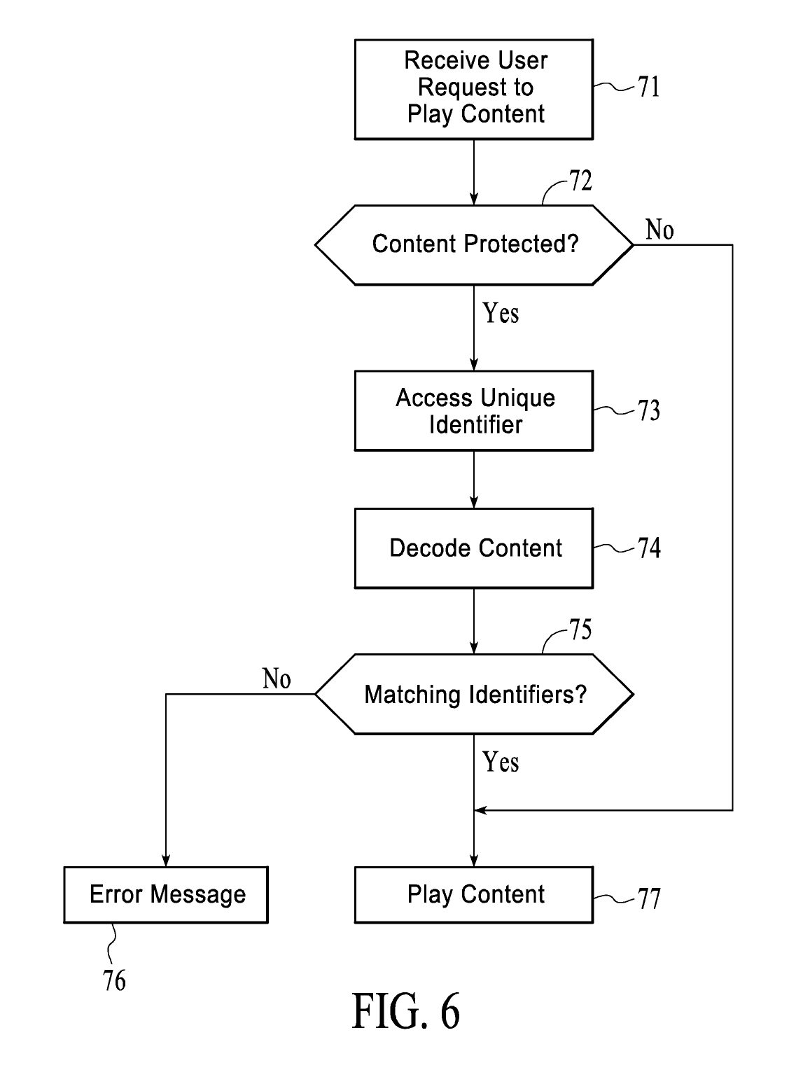

FIG. 6 is a simplified flow chart illustrating play of purchased content by a content user on content user device 40. In a block 71, content player 41 receives a user request to play purchased content. In a block 72, content player 41 checks to determine whether the content is protected, i.e., encoded. If not, in a block 77, content player plays the content using audio-visual controllers 46. Thus content player 41 is able to play unprotected content downloaded from the Internet or obtained from other sources.

If content is protected, in a block 73, content player 41 accesses unique identifier 43 from within content user device 40. In a block 74, content player decodes the purchased content to recover the proprietary digital content and unique identifier content encoded with the proprietary digital content.

In a block 75, content player compares unique identifier 43 accessed from content user device 40 to the unique identifier that was obtained from decoding the purchased content. If there is a unique identifier match, in block 77, content player 41 uses audio-visual controllers 46 to play the content. If unique identifier 43 does not match the unique identification embedded in the purchased content, this indicates the purchased content is not authorized to be played by consumer user device 40. In a block 76, content player 41 returns an error message. The error message can include an offer for the user to purchase the content through storefront interface 25.

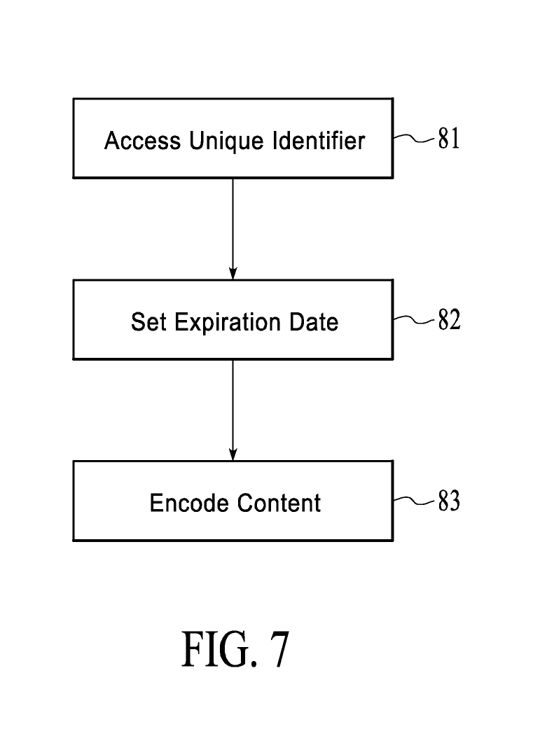

FIG. 7 is a simplified flow chart illustrating download of content having a time expiration. The content is downloaded from central content storage interface 25 to a content user using content user device 40 shown in FIG. 3. For example, the content user may pay for a time-limited license to play the content. During the course of the time-limited license, playing of the content is enabled on content player 41. When the time-limited license expires, the content can no longer be played on content player 41.

Alternatively, the content may be made available free to the content user for a short trial period. Alternatively, the content may be made available for a limited amount of time for a specific user to review, etc. In a block 81, storefront interface 25 accesses the unique identifier for the consumer user device which will receive the download. For example, this is done after payment from a content user, or is done after authorization from a content owner. In a block 82, an expiration date is set. For example, this is done based on payment made by the content user, or may be based on an authorization from the content owner for a specific content user to have access to the content for a specified period of time.

In a block 83, content encoder 22 encodes or re-encodes the time-expiring content to include the unique identifier obtained from content user device 40 and to include a time expiration.

If the time-expiring content may be played on more than one content user device, storefront interface 25 queues up the time-expiring content downloaded to be downloaded on authorized content user devices.

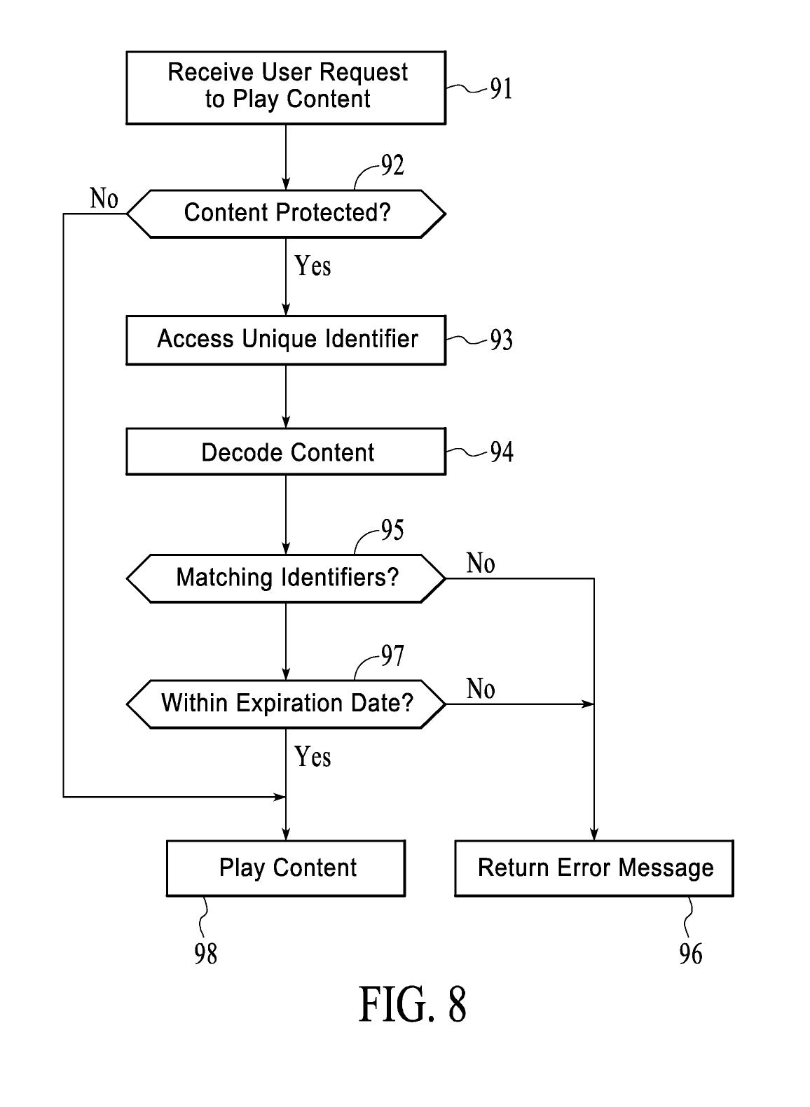

FIG. 8 is a simplified flow chart illustrating play of time-expiring content on content user device 40. In a block 91, content player 41 receives a user request to play purchased content. In a block 92, content player 41 checks to determine whether the content is protected, i.e., encoded. If not, in a block 98, content player plays the content using audio-visual controllers 46.

If content is protected, in a block 93, content player 41 accesses unique identifier 43 from content user device 40. In a block 94, content player 41 decodes the purchased content to recover the proprietary digital content and unique identifier encoded with the proprietary digital content.

For example, content player 41 adds unique identifiers associated with a consumer's account when importing digital digital files from digital storage media such as a compact disk (CD), a flash drive or any other hardware storage media that stores digital files. This prevents contents of a digital file from being exported or extracted from content user device 40 to another computer once the digital file has been imported and registered to an account.

For example, the actual digital files on digital storage media (e.g., a CD, a flash drive or any other hardware storage media that stores digital files) bought from a store get embedded with unique identifiers when a consumer imports the digital files into a digital player. This can prevent the digital files from being imported into another computer helping fight against piracy. For example, digital storage media when manufactured and sold to a consumer gets unique identifiers embedded once the consumer imports the files as well.

In a block 95, content player compares unique identifier 43 accessed from content user device 40 to the unique identifier that was obtained from decoding the purchased content. If there is not a match, this indicates the content is not authorized to play on content user device 40. In a block 96, content player 41 returns an error message. The error message may include an offer for the user to purchase the content through storefront interface 25, if the content is currently available for purchase.

If in block 95, there is a match, in a block 97, content player 41 checks if there is an expiration time/date to the content. If there is an expiration time/date to the content, content player 41 accesses the current date or the current date and time to determine whether the expiration date has passed. For example, content player 41 uses a source external to content user device 40 to obtain date and time, such as is available over a cellular network or a Wi-Fi network. If an expiration time/date has passed in block 96, content player 41 returns an error message. If there is there is no expiration time/date that has passed, in block 98 content player plays the content using audio-visual controllers 46.

Proprietary digital content that is uploaded from content owners, encoded by content encoder 22 and stored as encoded content on central content storage server 29 can, for example, be utilized downloaded and written to digital storage media for playing. For example, music files that use a proprietary music file extension can be downloaded by the content owner and sent to a music digital storage media manufacturer, such as a CD manufacturer or a flash drive manufacturer. When the manufactured music digital storage device, for example, include music files that can be played on a standard digital storage media player, such as included in a home stereo or a car stereo. For example, actual digital files on digital storage media bought from a store are embedded with unique identifiers when the consumer imports the files into a digital player. This prevents the digital files from being imported into another computer helping fight against piracy.

Files stored on digital storage media can also be imported into content storage 45 for playing on content player 41. For example, the files on the digital storage media can be uploaded (for example using a digital storage media player) connected to content user device 40. The files can be converted so that they are proprietary encoded music files embedded with the unique identifier for content player 41. Additional unique identifiers, as described above, can also be embedded in the proprietary encoded music files. For example, the user of content player logs in to storefront interface 25 so that the resources of central content storage server and any necessary permissions are obtained to perform the import/encoding/embedding functions. This also allows access to the unique identifiers associated with the user account for all content devices associated with the user. This also allows uploaded files from the digital storage media to be distributed, by central content storage server 29 to all content devices registered to the account for the user.

For example, proprietary encoded music files with embedded unique identifiers can be written to digital storage medias so that when files are extracted or imported from the digital storage media, they will be playable only on a content player with a unique identifier that matches one of the unique identifiers embedded on the files from the digital storage media.

In one embodiment, proprietary encoded music files are encoded and stored on digital storage media so that digital storage media player can play the music files while, when the proprietary encoded music files are extracted or imported from the digital storage media, they will be playable only on a content player with a unique identifier that matches one of the unique identifiers embedded on the files from the digital storage media.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A method to protect digital content, the method comprising:
installing a content player on a content user device;
providing a unique identifier for the content player installed on the content user device to a central content storage entity;
receiving, by the central content storage entity, proprietary digital content, the proprietary digital content including an original work of authorship protectable by copyright;
encoding, by the central content storage entity, the proprietary digital content to produce encoded content;
providing a storefront, by the central storage entity, that allows purchase of a license to play the proprietary digital content on the content player, including the following when the license to play the proprietary content on the content player is purchased:
embedding the unique identifier with the encoded content to produce content-player-specific digital content, and
forwarding the content-player-specific digital content from the central content storage entity to the content player installed on the content user device; and,
confirming, by the content player, that the unique identifier embedded with the encoded content matches the unique identifier provided for the content player before allowing play of the proprietary digital content on the content player.

2. A method as in claim 1 wherein embedding the unique identifier with the encoded content includes:
decoding the encoded content to recover the proprietary digital content;
adding the unique identifier to the proprietary digital content; and,
encoding the proprietary digital content with the unique identifier to produce the content-player-specific digital content.

3. A method as in claim 1 wherein embedding the unique identifier with the encoded content includes:
adding the unique identifier to the encoded content; and,
further encoding the encoded content with the proprietary digital content to produce the content-player-specific digital content.

4. A method as in claim 1 wherein embedding the unique identifier with the encoded content includes:
using the unique identifier as part of an encryption key to produce the content-player-specific digital content.

5. A method as in claim 1 wherein embedding the unique identifier with the encoded content includes:
embedding with the encoded content a second unique identifier that identifies a second content player within a second content user device.

6. A method as in claim 1 wherein embedding the unique identifier with the encoded content includes:
embedding with the encoded content a plurality of additional unique identifiers, wherein each additional unique identifier identifies an additional content player within an additional content user device.

7. A method as in claim 1:
wherein embedding the unique identifier with the encoded content includes:
including an expiration date within the encoded content; and,
wherein the method additionally comprises:
confirming, by the content player, that the expiration date has not passed before allowing play of the proprietary digital content on the content player.

8. A method to protect digital content, the method comprising:
installing a content player on a content user device;
providing a unique identifier for the content player installed on the content user device to a central content storage entity;
purchasing from a storefront on the central content storage entity a license to play proprietary digital content stored on the central content storage, wherein the proprietary digital content includes an original work of authorship protectable by copyright;
downloading content-player-specific digital content from the central content storage to the content user device, the content-player-specific digital content including encoded content of the proprietary digital content embedded with the unique identifier; and,
confirming, by the content player, that the unique identifier embedded with the encoded content matches the unique identifier provided for the content player before allowing play of the proprietary digital content on the content player.

9. A method as in claim 8 wherein the content-player-specific digital content is produced by:
adding the unique identifier to the proprietary digital content; and,
encoding the proprietary digital content with the unique identifier to produce the content-player-specific digital content.

10. A method as in claim 8 wherein the content-player-specific digital content is produced by:
encoding the proprietary digital content to produce encoded content;
further encoding the encoded content with the proprietary digital content to produce the content-player-specific digital content.

11. A method as in claim 8 wherein the content-player-specific digital content is produced by:
encoding the proprietary digital content to produce encoded content; and,
adding the unique identifier to the encoded content to produce the content-player-specific digital content.

12. A method as in claim 8 wherein the content-player-specific digital content includes a second unique identifier that identifies a second content player within a second content user device.

13. A method as in claim 8 additionally comprising:
monitoring activity on the content user device when the content player plays content-player-specific digital content;
pausing play of the content-player-specific digital content when there is detected activity that suggest the content-player-specific digital content is being captured for storage.

14. A method as in claim 8 wherein the content-player-specific digital content includes an expiration date within the encoded content; and,
wherein the method additionally comprises:
confirming, by the content player, that the expiration date has not passed before allowing play of the proprietary digital content on the content player.

15. A method to protect digital content, the method comprising:
receiving, by a central content storage entity, a unique identifier for a content player installed on a content user device;
receiving, by the central content storage entity, proprietary digital content, the proprietary digital content including an original work of authorship protectable by copyright;
encoding, by the central content storage entity, the proprietary digital content to produce encoded content;
providing a storefront, by the central storage entity, that allows purchase of a license to play the proprietary digital content on the content player, including the following when the license to play the proprietary content on the content player:
embedding the unique identifier with the encoded content to produce content-player-specific digital content, and
forwarding the content-player-specific digital content from the central content storage entity to the content player installed on the content user device.

16. A method as in claim 15 wherein embedding the unique identifier with the encoded content includes:
decoding the encoded content to recover the proprietary digital content;
adding the unique identifier to the proprietary digital content; and,
encoding the proprietary digital content with the unique identifier to produce the content-player-specific digital content.

17. A method as in claim 15 wherein embedding the unique identifier with the encoded content includes:
adding the unique identifier to the encoded content; and,
further encoding the encoded content with the proprietary digital content to produce the content-player-specific digital content.

18. A method as in claim 15 wherein embedding the unique identifier with the encoded content includes:
adding the unique identifier to the encoded content to produce the content- player-specific digital content.

19. A method as in claim 15 wherein embedding the unique identifier with the encoded content includes:
including an expiration date within the encoded content.

20. A method as in claim 15 additionally comprising:
embedding at least one unique identifier into files stored on digital storage media so that when the files are extracted or imported from the digital storage media, the files will be playable only on a content player with a unique identifier that matches one of the at least one unique identifier embedded into the files stored on the digital storage media.
